(19) United States
(12) Patent Application Publication
(10) Pub. No.: US 2025/0376893 A1
(43) Pub. Date: Dec. 11, 2025

(54) INSECT SCREEN

(71) Applicant: SAINT-GOBAIN ADFORS, Courbevoie (FR)

(72) Inventors: James GRIFFIN, Amherst, NY (US); Kevin D. ROGERS, Batavia, NY (US); Jenni Ann BRITO BRAUM TABER, Pueblo (MX); Courtney MICHAELS, Natick, MA (US); Justin HARRIS, Milford, MA (US)

(21) Appl. No.: 19/230,287

(22) Filed: Jun. 6, 2025

Related U.S. Application Data
(60) Provisional application No. 63/657,510, filed on Jun. 7, 2024.

(51) Int. Cl. E06B 9/52; D03D 9/00; D03D 15/267; D03D 15/283

(52) U.S. Cl. CPC E06B 9/52; D03D 9/00; D03D 15/267; D03D 15/283; D10B 2331/04; D10B 2401/062; D10B 2401/063; D10B 2503/00; E06B 2009/524

(57) ABSTRACT

An insect screen including: a frame, wherein the frame has a flexible response when a pressure is applied to the frame and maintains a rigid shape when secured in a building opening; and an open mesh substrate attached to the frame, wherein the open mesh substrate comprises a set of first fibers oriented in a first direction of said open mesh substrate, wherein the set of first fibers has a first adhesion strength to the frame; and a set of second fibers oriented in a second direction that is perpendicular to the first direction, wherein the set of second fibers has a second adhesion strength to the frame, wherein the second direction is perpendicular to the first direction, wherein the first set of fibers and the second set of fibers are configured to intersect, and wherein the first adhesion strength is greater than the second adhesion strength.

### CROSS-REFERENCE TO RELATED APPLICATIONS

This application claims priority under 35 U.S.C. § 119 (e) to U.S. Provisional Patent Application No. 63/657,510, entitled “INSECT SCREEN”, by James GRIFFIN et al., filed Jun. 7, 2024, which is assigned to the current assignee hereof and incorporated herein by reference in its entirety.

### FIELD OF THE DISCLOSURE

The present disclosure relates to insect screens and to methods of making the insect screens.

### BACKGROUND

Woven screens, such as an insect screen used to cover a window opening, are susceptible to permanent deformation. Woven screens are typically taut in both the direction parallel to and perpendicular to the direction in which the screen is inserted into a window opening, to prevent wrinkles and to improve the appearance of the screen when it covers the window. The attempt to repetitively remove and insert a screen may cause the woven screen to permanently deform, losing its aesthetic view through the window. Excessive force may also be applied to the woven screen when removing and inserting the screen, causing damage to the woven screen and the frame.

Accordingly, there is a need for an improved insect screen.

### SUMMARY

In an embodiment, an insect screen includes: a frame, wherein the frame has a flexible response when a pressure is applied to the frame and maintains a rigid shape when secured in a building opening; and an open mesh substrate attached to the frame, wherein the open mesh substrate comprises a set of first fibers oriented in a first direction of said open mesh substrate, wherein the set of first fibers has a first adhesion strength to the frame; and a set of second fibers oriented in a second direction that is perpendicular to the first direction, wherein the set of second fibers has a second adhesion strength to the frame, wherein the second direction is perpendicular to the first direction, wherein the first set of fibers and the second set of fibers are configured to intersect, and wherein the first adhesion strength is greater than the second adhesion strength.

In another embodiment, a method of making an insect screen includes: orienting in a first direction of an open mesh substrate a first set of fibers; orienting in a second direction of the open mesh substrate a second set of fibers, where the second direction is perpendicular to the first direction, wherein the first set of fibers and the second set of fibers are configured to intersect; fixing the first set of fibers together with the second set of fibers; and fixing the open mesh substrate to a frame, wherein the frame has a flexible response when a pressure is applied to the frame and maintains a rigid shape when secured in a building opening; wherein the first set of fibers has a first adhesion strength to the frame and the second set of fibers has a second adhesion strength to the frame and wherein the first adhesion strength is greater than the second adhesion strength.

In yet another embodiment, an insect screen includes: a frame, wherein the frame has a flexible response when a pressure is applied to the frame and maintains a rigid shape when secured in a building opening; and an open mesh substrate attached to the frame, wherein the open mesh substrate includes a set of polymer fibers oriented in a first direction of said open mesh substrate, wherein the set of polymer fibers has a first adhesion strength to the frame; and a set of coated fiberglass fibers oriented in a second direction that is perpendicular to the first direction, wherein the set of coated fiberglass fibers has a second adhesion strength to the frame, wherein the second direction is perpendicular to the first direction, wherein the set of polymer fibers and the set of coated fiberglass fibers are configured to intersect, and wherein the first adhesion strength is greater than the second adhesion strength.

### BRIEF DESCRIPTION OF THE DRAWINGS

Embodiments are illustrated by way of example and are not limited in the accompanying figures.

FIG. 1 includes an illustration of an open mesh substrate in accordance with an embodiment described herein.

FIG. 2 is a perspective view of the insect screen positioned in a building opening in accordance with an embodiment described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application.

Before addressing details of the embodiments described below, some terms are defined or clarified. The term “warp” is intended to denote the fibers running lengthwise, or parallel to a machine direction, within the open mesh substrate and the term “weft” is intended to denote the fibers running widthwise, or parallel to a cross direction, in the open mesh substrate.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts.

The present invention provides an insect screen including a frame and an open mesh substrate. The frame has a flexible response when a pressure is applied to the frame and maintains a rigid shape when secured in a building opening. The open mesh substrate is attached to the frame. The open mesh substrate includes a first set of fibers and a second set of fibers. The first set of fibers is oriented in a first direction of the open mesh substrate and has a first adhesion strength to the frame. The second set of fibers is oriented in a second direction of the open mesh substrate and in an embodiment, is perpendicular to the first direction. The second set of fibers has a second adhesion strength to the frame. The first set of fibers and the second set of fibers are configured to intersect. Further, the first adhesion strength is greater than the second adhesion strength. An insect screen as described can resist deformation and maintain its structural integrity even as the frame is flexed repeatedly over any reasonable range of ambient temperatures.

The open mesh substrate includes the first set of fibers, which includes a plurality of first fibers. The open mesh substrate also includes the second set of fibers, which includes a plurality of second fibers. In an embodiment, the first and/or the second fibers may be described as monofilaments. Skilled artisans will appreciate, however, that each of the first set of fibers and second set of fibers may include other configurations. For example, one or more of the first set of fibers and the second set of fibers may include a multi-strand, plied or unplied (e.g., ordered or unordered) configuration of one or more suitable materials. In an embodiment, the multi-strand plied configuration includes an ordered configuration such as a yarn. One or more of the first set of fibers and the second set of fibers also may include a multi-strand unordered configuration, such as a roving. Any suitable configuration for each of the first and second set of fibers is envisioned. In an embodiment, the first set of fibers and second set of fibers include the same configuration. In another embodiment, the first and second set of fibers include different configurations.

Any suitable materials for each of the first set of fibers and the second set of fibers, including any suitable organic or inorganic material, are envisioned for the open mesh substrate. In an embodiment, suitable materials include a polymeric material, a metal material, a fiberglass, or combination thereof. In an embodiment, the first set of fibers and the second fibers may include fiberglass, steel, aluminum, polyethylene, polypropylene, polyester, polyamide, cellulose, or any combination thereof. In an embodiment, the first set of fibers and the second set of fibers are different materials to provide different properties to the insect screen within a flexible frame. In a particular embodiment, the first set of fibers includes polyester. In a more particular embodiment, the first set of fibers consists of polyester. In an embodiment, the second set of fibers includes fiberglass, with the proviso that the fiberglass is coated with at least one polymer coating. In a more particular embodiment, the second set of fibers consists of coated fiberglass.

Any suitable dimension for each of the first set of fibers and the second set of fibers is also envisioned for the open mesh substrate. In an embodiment, the first set of fibers and the second set of fibers can include various diameters. For example, the diameter of the first set of fibers and the second set of fibers can include a diameter in the range of between about 120 microns and about 635 microns considering torsion in the yarn. In an embodiment, the first set of fibers and the second set of fibers have the same diameter. In another embodiment, the first set of fibers and the second set of fibers have different diameters.

At least one polymer coating may be included on the first set of fibers, the second set of fibers, or combination thereof. The at least one polymer coating for the first set of fibers, the second set of fibers, or combination thereof includes any reasonable polymer. In an embodiment, the polymer coating includes polyvinyl chloride (PVC), polyethylene, polypropylene, polyamide, cellulose, acrylic, polylactic acid, latex, syndiotactic polystyrene, styrene acrylic, styrene-butadiene rubber, or any combination thereof. In a particular embodiment, the polymer coating is plastisol and the plastisol includes a dispersion of PVC within a blending resin, a plasticizer, and one or more additives. In an embodiment, the polymer coating includes suitable additives, such as a colorant, a stabilizer, a surfactant, a thickener, a thermal stabilizer, an anti-static agent, a lubricant, a processing aid, an impact modifier, a filler, a flame retardant, a biocide, a blowing agent, a smoke-suppressor, or any combination of these substances.

The thickness of the at least one polymer coating on their respective fibers includes any reasonable range of thicknesses. In a particular embodiment, the at least one polymer coating has a thickness of between about 30 microns and about 200 microns. The polymer coating can also coat any suitable amount of each fiber. For example, the polymer coating can coat substantially all of a first set of fibers and the second set of fibers, respectively. In another embodiment, the polymer coating can coat at least 50% of the first set of fibers and the second set of fibers respectively, such as at least 60%, at least 70%, or even at least 75%. In yet another embodiment, the polymer coating can include a uniform coating, a homogenous coating, or a continuous coating on the first set of fibers and the second set of fibers, respectively. In particular, the open mesh substrate has a total thickness of about 0.1 mm to about 1.0 mm as measured by ASTM D1777, the thickness including the fiber and the polymer coating.

Within the open mesh substrate, the first set of fibers and the second set of fibers can be configured to intersect such that they may be woven together using any reasonable weave. In a particular embodiment, the first set of fibers and the second set of fibers are configured in a plain weave where each of the second fibers are carried over and under each of the first fibers, with each row of second fibers alternating, to produce a high number of intersections between the first set of fibers and the second set of fibers. For each weave used, the open mesh substrate and the configurations of the first set of fibers and the second set of fibers can also be altered by changing the densities (e.g., increasing or decreasing the number of fibers in a given distance, such as increasing or decreasing the number of fibers per inch) of either or both of the first set of fibers or the second set of fibers in their respective directions.

The directions in which the first set of fibers and the second set of fibers are oriented within the open mesh substrate also include any reasonable orientations. For example, the first set of fibers can be oriented in a main direction of the open mesh substrate, such as a direction that is parallel to the length of the open mesh substrate. In an embodiment, the second set of fibers may be oriented in a direction of the open mesh substrate that is different from the orientation of the first set of fibers, such as in a cross direction that is parallel to the width of the open mesh substrate or perpendicular to the orientation of the first set of fibers. In a particular embodiment, the first set of fibers includes the warp of the open mesh substrate and the second set of fibers includes the weft of the open mesh substrate.

The construction of each of the first set of fibers and the second set of fibers in the open mesh substrate include any reasonable constructions, depending on the purpose for which the open mesh substrate is intended. In an embodiment, the construction of each of the first set of fibers and the second set of fibers is between about 1 fiber per centimeter to about 30 fibers per centimeter in their respective directions. The construction of fibers in the first and second directions may be the same or different. For instance, the first set of fibers is present at 1 fiber per centimeter to 15 fibers per centimeter, such as 4 fibers per centimeter to 10 fibers per centimeter and the second set of fibers is present at 1 fiber per centimeter to 15 fibers per, such as 3 fibers per centimeter to 8 fibers per centimeter. In a particular embodiment, the construction of the first set of fibers and the construction of the second set of fibers create an open mesh substrate that is designed to prevent insects from entering through a window or passing through the screen. For instance, the construction of the first and second set of fibers provide an open mesh substrate that has an openness of greater than 30%, such as greater than 40%, such as greater than 50%, such as greater than 60%, such as greater than 70%, such as greater than 80%, or even greater than 90%. “Openness” as used herein refers to the amount of visibility through the open mesh substrate when viewing at 0° Celsius incidence in front of the insect screen.

The open mesh substrate has further advantageous properties. With the use of the first set of fibers and the second set of fibers that are different, desirable properties are achieved for the open mesh substrate. For instance, the open mesh substrate has a stiffness of about 80 mg to about 700 mg, such as about 300 mg to about 600 mg in the first direction as measured by ASTM D3656. Further, the open mesh substrate has a tear of about 75 Newtons to about 150 Newtons as measured by ASTM D5735. Further, the open mesh substrate has a fabric weight of 120 g/m² to 270 g/m² as measured by ASTM D3776.

Any use of the open mesh substrate is envisioned. The open mesh substrate can include a variety of dimensions and is useful for both indoor and outdoor applications. For example, the width of the open mesh substrate can be between about 0.2 meters and about 2.7 meters and the length of the open mesh substrate can be between about 0.2 meters and about 10 meters. In an embodiment, the open mesh substrate may be part of a window covering system that includes a frame to prevent insects from entering through the window by passing through the open mesh substrate. In a particular embodiment, the open mesh substrate is attached to a flexible frame that may be attached to an outer frame of the window to be covered by the insect screen. The insect screen can be inserted and removed repeatedly without deformation as described above over any reasonable range of temperatures, including a temperature range of about −40° Celsius to about +50° Celsius.

In a particular embodiment, the open mesh substrate is attached to a frame. In a particular embodiment, the frame is flexible. For instance, the frame has a flexible response when a pressure is applied to the frame and maintains a rigid shape when secured in a building opening. In an example, when the pressure is applied to bend the frame inward towards the center of the open mesh substrate, the frame bends but does not break. When pressure is released, the frame returns to its original shape and securely fastens into a building opening, such as a window or a door. For instance, the frame has a spring-like characteristic which allows easy removal and insertion of the insect screen into the building opening. In a particular embodiment, the frame does not permanently deform when placed under temporary pressure/distortion to insert and remove the insect screen. In an embodiment, the insect screen is placed into a groove that houses the insect screen on the outside of the building opening that is exposed to the outside environment.

Any configuration and material is envisioned for the frame. For instance, the frame includes any number of spring-like side members, the number of sides typically determined by the building opening. In an embodiment, the frame has at least one spring-like side member. Any reasonable material for the frame is envisioned. In an embodiment the frame includes a metal, a polymer, a natural material, or combination thereof. In a particular embodiment the frame includes a metal such as spring steel. Further, the frame includes a defined shape that is typically dependent on the building opening it is covering, such as, for example, a rectangle, a circle, a triangle, or a polygon. The size and the shape of the frame are typically dependent upon the opening to be covered.

Turning to a method of making any exemplary insect screen, the first set of fibers and the second set of fibers as described above are provided. In an embodiment, each of the fibers of the first set of fibers and the second set of fibers are coated with the polymer coating by any reasonable coating method, such as by a dip coating or extrusion coating method. In a particular embodiment, the fibers can be coated via an extrusion process.

Once coated, the first set of fibers and the second set of fibers may be oriented in any reasonable orientations and configured to intersect in preparation for being woven or knitted together. Any reasonable weaving or knitting technique is envisioned. The first set of fibers are oriented in the main direction of the open mesh substrate which, in a particular embodiment, can include the warp of the open mesh substrate while the second set of fibers are oriented in a different direction, such as the cross direction of the open mesh substrate which, in an embodiment, can include the weft of the open mesh substrate. In another particular embodiment, the first set of fibers are oriented in a direction that includes the weft of the open mesh substrate and the second set of fibers are oriented in a direction that includes the warp of the open mesh substrate. The first set of fibers and the second set of fibers are woven together using a plain weave, a leno weave, or a half leno weave as described above or using any other reasonable weaving technique. For example, the first fibers and the second fibers can be woven together using machines produced by Sulzer, Picanol, Dornier, or Smit Textile. Any knitting configuration is envisioned that yields an open mesh fabric including, but not limited to, tricot, raschel, and bobbinet.

The open mesh substrate can be fixed with any reasonable means to secure, or fix, the position of the first set of fibers and the second set of fibers relative to one another and their intersections within the open mesh substrate by, for example, curing the polymer coating. To “fix” the position of the first set of fibers and the second set of fibers relative to one another and their intersections, as used herein, is to refer to the position of the fibers relative to one another and their intersections as remaining unchanged even as the open mesh substrate is fixed to the frame. In a particular embodiment, the polymer coating on the first set of fibers and the second set of fibers may also be used to also attach the open mesh substrate to the frame.

In an embodiment, the fibers of the open mesh substrate are fixed using a heated means. Any reasonable heating temperature and conditions are envisioned depending upon the polymer coating. For example, the heating temperature can include a value in the range of between about 140° Celsius to about 400° Celsius. The time needed to fix the open mesh substrate can also include various times, including a curing time of between about 1 second to about 30 seconds, depending on the stiffness values required. In a particular embodiment, tentering or thermal bonding can be used to cure the polymer coating and to fix the intersections between the first fibers and the second fibers. In a further particular embodiment, the heat applied to the open mesh substrate cures the polymer coating at a single temperature. Skilled artisans will further appreciate that any reasonable sequence of coating, curing or fixing, and weaving steps are envisioned to make the open mesh substrate.

The open mesh substrate is secured to the frame via welding, an adhesive, or combination thereof. In an embodiment, heat, pressure, or combination thereof may be used to fix the open mesh substrate to the frame. The open mesh substrate may be placed in the frame by any reasonable means necessary. Heat and/or pressure may be applied and the polymer coating on the first set of fibers and the second set of fibers can soften to adhere the open mesh substrate to the frame. Any reasonable heat and/or pressure conditions are envisioned to provide adhesion and are dependent on the polymer coating. In an embodiment, any reasonable additional adhesive composition may be used. In an embodiment, the frame and open mesh substrate is substantially free of an additional adhesive composition at the point of attachment between the frame and the open mesh substrate.

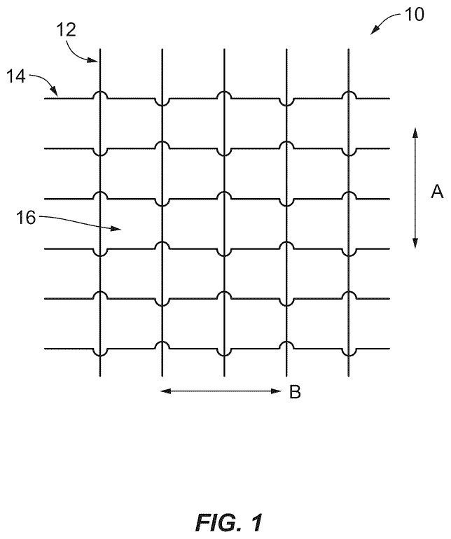

Turning to FIG. 1, an open mesh substrate 10 is illustrated. The open mesh substrate 10 includes first set of fibers 12 that include a polymer coating (not shown) and second set of fibers 14 that include a polymer coating (not shown) as described above. First set of fibers 12 are a plurality of fibers oriented in a direction parallel to line A that, in an embodiment, can include the main direction of the open mesh substrate 10. In an embodiment, line A is also parallel to the warp direction of open mesh substrate 10. Second set of fibers 14 are oriented in a cross direction of the open mesh substrate 10 that is different than the main direction. That is, second set of fibers 14 are a plurality of fibers oriented in a direction parallel to line B that, in an embodiment, is perpendicular to line A and in the weft direction of open mesh substrate 10. In a particular embodiment, the first set of fibers 12 comprise the warp of open mesh substrate 10 and the second set of fibers 14 comprise the weft of open mesh substrate 10. In an embodiment, the first set of fibers 12 include polyester fibers and the second set of fibers 14 include fiberglass fibers. First set of fibers 12 and second set of fibers 14 are configured to intersect in a plain weave, where each of second set of fibers 14 are carried over and under each of first set of fibers 12 and each row of second fibers 14 alternates to produce a high number of intersections of first fibers 12 and second fibers 14. As illustrated, there is open space 16 between first set of fibers 12 and second set of fibers 14 for visibility through the open mesh substrate.

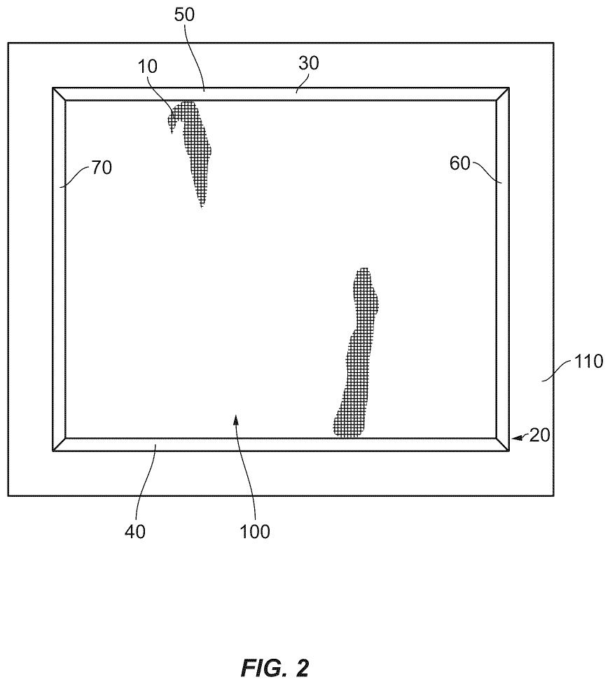

FIG. 2 is a perspective view of the insect screen 100 positioned in a building opening 110. The insect screen 100 consists of a frame 20 including a frame perimeter 30 defining a frame opening. An open mesh substrate 10 as described in FIG. 1 fills the opening defined by the frame perimeter 30. The frame 20 supports the open mesh substrate 10 on all sides of the open mesh substrate 10. The frame 20 is sufficiently rigid when placed in a building opening 110 to support the open mesh substrate tautly and to allow handling when the insect screen 100 is placed in or removed from a window or door unit.

As illustrated, the frame 20 includes side members, 40, 50, 60, and 70. As illustrated, the frame 20 includes two pairs of opposed frame members. A first pair of opposed frame members 40 and 50 is oriented along a horizontal frame axis, which is the “long direction” of the frame. In an embodiment, the first set of fibers 12 of polyester fibers are perpendicular to the long direction. A second pair of opposed frame members 60 and 70 is oriented along a vertical frame axis, which is the “short direction” of the frame. In an embodiment, the second set of fibers 14 of coated fiberglass fibers are perpendicular to the short direction. The four frame members 40, 50, 60, and 70 form a square or rectangle shape. However, the frame may be any shape. As described, any one of the frame members 40, 50, 60, and 70 may be the at least one spring-like side member. In an embodiment, any one, two, three, or four frame members may be spring-like. Further, the frame 20 may be constructed of a single unitary member or any number of separate members. Any additional components of the frame may be present that are commonly used to provide structure and/or secure the frame and/or open mesh substrate.

When the insect screen includes the first set of fibers that is different than the second set of fibers, it allows the open mesh substrate of the insect screen to resist permanent deformation associated with flexing the frame to install and remove the insect screen. Deformation can include wrinkles, kinked or crimped fibers, tears or any other undesirable configuration of the fibers in open mesh substrate 10. In an example, with a flexible insect screen, the first set of fibers of the open mesh substrate are placed under a higher spring effect when flexing occurs on the horizontal members 40, 50. The different set of fibers with different mechanical properties provides advantageous characteristics for the flexible insect screen. For instance, the open mesh substrate has a desirable adhesion to the frame. In an embodiment, the first set of fibers, such as polyester fibers, have a first adhesion that is greater than 5.8 pound force (lbf), such as 5.8 lbf to 8.5 lbf as measured by a modified ASTM D5035. In an embodiment, the second set of fibers, such as fiberglass fibers, have a second adhesion that is less than 5.5 pound force (lbf), such as 3.5 lbf to 5.5 lbf as measured by a modified ASTM D5035.

The open mesh substrate has further properties that are advantageous such as, for example, elongation, stiffness, and tear. In an embodiment, the open mesh substrate has an elongation at rupture of greater than 20%, such as 20% to 40% in the first direction as measured by an ASTM D5035. In an embodiment, the open mesh substrate has an elongation at rupture of less than 15%, such as 1% to 15% in the second direction as measured by an ASTM D5035. The open mesh substrate has a stiffness of about 100 mg to about 700 mg, such as about 300 mg to about 600 mg in the first direction as measured by ASTM D3656. In an embodiment, the open mesh substrate has a tear of about 75 Newtons to about 150 Newtons as measured by ASTM D5735.

Further, the screen has a fabric stability of about 50 Newtons to about 80 Newtons in the second direction as measured by ASTM D4912 and about 30 Newtons to about 70 Newtons in the first direction as measured by ASTM D4912.

The insect screen as described is able to avoid deformation of the open mesh substrate and the fibers within the open mesh substrate as well as damage to the frame. The insect screen is able to avoid deformation and damage despite repeated use of the insect screen over a range of temperatures. Although primarily discussed as an insect screen for a building opening, any use in any temporary or permanent structure is envisioned where flexibility of a frame and insect barrier properties are desired.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. An insect screen including: a frame, wherein the frame has a flexible response when a pressure is applied to the frame and maintains a rigid shape when secured in a building opening; and an open mesh substrate attached to the frame, wherein the open mesh substrate comprises a set of first fibers oriented in a first direction of said open mesh substrate, wherein the set of first fibers has a first adhesion strength to the frame; and a set of second fibers oriented in a second direction that is perpendicular to the first direction, wherein the set of second fibers has a second adhesion strength to the frame, wherein the second direction is perpendicular to the first direction, wherein the first set of fibers and the second set of fibers are configured to intersect, and wherein the first adhesion strength is greater than the second adhesion strength.

Embodiment 2. A method of making an insect screen including: orienting in a first direction of an open mesh substrate a first set of fibers; orienting in a second direction of the open mesh substrate a second set of fibers, where the second direction is perpendicular to the first direction, wherein the first set of fibers and the second set of fibers are configured to intersect; fixing the first set of fibers together with the second set of fibers; and fixing the open mesh substrate to a frame, wherein the frame has a flexible response when a pressure is applied to the frame and maintains a rigid shape when secured in a building opening; wherein the first set of fibers has a first adhesion strength to the frame and the second set of fibers has a second adhesion strength to the frame and wherein the first adhesion strength is greater than the second adhesion strength.

Embodiment 3. The insect screen or the method of making the insect screen in accordance with any of the preceding embodiments, wherein the first set of fibers and the second set of fibers include fiberglass, steel, aluminum, polyester, polyethylene, polypropylene, polyamide, cellulose or combinations thereof.

Embodiment 4. The insect screen or the method of making the insect screen in accordance with embodiment 3, wherein the first set of fibers includes polyester.

Embodiment 5. The insect screen or the method of making the insect screen in accordance with embodiment 4, wherein the first set of fibers consists of polyester.

Embodiment 6. The insect screen or the method of making the insect screen in accordance with embodiment 3, wherein the second set of fibers includes fiberglass.

Embodiment 7. The insect screen or the method of making the insect screen in accordance with embodiment 6, wherein the second set of fibers consists of fiberglass.

Embodiment 8. The insect screen or the method of making the insect screen in accordance with any of the preceding embodiments, wherein the first direction includes the warp of the open mesh substrate and the second direction includes the weft of the open mesh substrate.

Embodiment 9. The insect screen or the method of making the insect screen in accordance with any of the preceding embodiments, wherein the first set of fibers and the second set of fibers are configured in a plain weave.

Embodiment 10. The insect screen or the method of making the insect screen in accordance with any of the preceding embodiments, wherein the first set of fibers and the second set of fibers in the open mesh substrate are present at 1 fiber per centimeter to 30 fibers per centimeter.

Embodiment 11. The insect screen or the method of making the insect screen in accordance with embodiment 10, wherein the first set of fibers is present at 1 fiber per centimeter to 15 fibers per centimeter, such as 4 fibers per centimeter to 10 fibers per centimeter.

Embodiment 12. The insect screen or the method of making the insect screen in accordance with embodiment 10, wherein the second set of fibers is present at 1 fiber per centimeter to 15 fibers per, such as 3 fibers per centimeter to 8 fibers per centimeter.

Embodiment 13. The insect screen or the method of making the insect screen in accordance with any of the preceding embodiments, further including at least one polymer coating on the first set of fibers, the second set of fibers, or combination thereof.

Embodiment 14. The insect screen or the method of making the insect screen in accordance with embodiment 13, wherein the polymer coating includes plastisol, polyvinyl chloride (PVC), polyethylene, polypropylene, polyamide, cellulose, acrylic, polylactic acid, latex, syndiotactic polystyrene, styrene acrylic, styrene-butadiene rubber, or combinations thereof.

Embodiment 15. The insect screen or the method of making the insect screen in accordance with embodiment 13, wherein the at least one polymer coating has a thickness within a range of between about 30 microns and about 200 microns.

Embodiment 16. The insect screen or the method of making the insect screen in accordance with any of the preceding embodiments, wherein the open mesh substrate has an openness of greater than 30%.

Embodiment 17. The insect screen or the method of making the insect screen in accordance with any of the preceding embodiments, wherein the open mesh substrate is secured to the frame via welding, an adhesive, or combination thereof.

Embodiment 18. The insect screen or the method of making the insect screen in accordance with any of the preceding embodiments, wherein the open mesh substrate has a fabric weight of 120 g/m² to 270 g/m² as measured by ASTM D3776.

Embodiment 19. The insect screen or the method of making the insect screen in accordance with any of the preceding embodiments, wherein the first adhesion is greater than 5.8 pound force (lbf), such as 5.8 lbf to 8.5 lbf as measured by a modified ASTM D5035.

Embodiment 20. The insect screen or the method of making the insect screen in accordance with any of the preceding embodiments, wherein the second adhesion is less than 5.5 pound force (lbf), such as 3.5 lbf to 5.5 lbf as measured by a modified ASTM D5035.

Embodiment 21. The insect screen or the method of making the insect screen in accordance with any of the preceding embodiments, wherein the open mesh substrate has a total thickness of about 0.1 mm to about 1.0 mm as measured by ASTM D1777.

Embodiment 22. The insect screen or the method of making the insect screen in accordance with any of the preceding embodiments, wherein the screen has a fabric stability of about 50 Newtons to about 80 Newtons in the second direction as measured by ASTM D4912.

Embodiment 23. The insect screen or the method of making the insect screen in accordance with any of the preceding embodiments, wherein the screen has a fabric stability of about 30 Newtons to about 70 Newtons in the first direction as measured by ASTM D4912.

Embodiment 24. The insect screen or the method of making the insect screen in accordance with any of the preceding embodiments, wherein the open mesh substrate has a stiffness of about 100 mg to about 700 mg, such as about 300 mg to about 600 mg in the first direction as measured by ASTM D3656.

Embodiment 25. The insect screen or the method of making the insect screen in accordance with any of the preceding embodiments, wherein the open mesh substrate has a tear strength of about 75 Newtons to about 150 Newtons as measured by ASTM D5735.

Embodiment 26. The insect screen or the method of making the insect screen in accordance with any of the preceding embodiments, wherein the open mesh substrate has an elongation at rupture of greater than 20%, such as 20% to 40% in the first direction as measured by ASTM D5035.

Embodiment 27. The insect screen or the method of making the insect screen in accordance with any of the preceding embodiments, wherein the open mesh substrate has an elongation at rupture of less than 15%, such as 1% to 15% in the second direction as measured by ASTM D5035.

Embodiment 28. The insect screen or the method of making the insect screen in accordance with any of the preceding embodiments, wherein the frame includes at least one spring-like side member.

Embodiment 29. The insect screen or the method of making the insect screen in accordance with any of the preceding embodiments, wherein the frame includes spring steel.

Embodiment 30. The insect screen or the method of making the insect screen in accordance with any of the preceding embodiments, wherein the frame includes a defined shape comprising a rectangle, a circle, a triangle, or polygon.

Embodiment 31. The method of making the insect screen in accordance with embodiment 2, further including weaving the first set of fibers with the second set of fibers using a plain weave.

Embodiment 32. The method of making the insect screen in accordance with embodiment 2, further including coating the first set of fibers and the second set of fibers with a polymer coating.

Embodiment 33. The method of making the insect screen in accordance with embodiment 32, further including fixing the first set of fibers together with the second set of fibers with heat.

Embodiment 34. The method of making the insect screen in accordance with embodiment 2, wherein fixing the open mesh substrate to the frame includes welding the open mesh substrate to the frame.

Embodiment 35. An insect screen including: a frame, wherein the frame has a flexible response when a pressure is applied to the frame and maintains a rigid shape when secured in a building opening; and an open mesh substrate attached to the frame, wherein the open mesh substrate includes a set of polymer fibers oriented in a first direction of said open mesh substrate, wherein the set of polymer fibers has a first adhesion strength to the frame; and a set of coated fiberglass fibers oriented in a second direction that is perpendicular to the first direction, wherein the set of coated fiberglass fibers has a second adhesion strength to the frame, wherein the second direction is perpendicular to the first direction, wherein the set of polymer fibers and the set of coated fiberglass fibers are configured to intersect, and wherein the first adhesion strength is greater than the second adhesion strength.

The following example is provided to better disclose and teach processes and compositions of the present invention. It is for illustrative purposes only, and it must be acknowledged that minor variations and changes can be made without materially affecting the spirit and scope of the invention as recited in the claims that follow.

### EXAMPLES

### Sample Preparation

Using a blade and a ruler, strips of open mesh substrate were cut with the frame attached. Strips are 1-inch wide and 4-inches long. The open mesh substrate had polyester fibers in the warp direction and fiberglass fibers in the weft direction. A minimum of six samples were cut on each edge of the frame.

Tensile testing was performed on an Instron machine with a 1 kN load cell. The strips were pulled at a rate of 2 in/min until a failure occurs. The maximum tensile force was recorded after failure. There was a 3-inch gauge length between the top edge of the frame and the bottom of the upper clamp.

Pneumatic 3-inch clamps were used to secure the screen during the tensile testing. Manual 3-inch clamps were used to secure the frame at the bottom. It was important to keep the screen level to the ground during testing and to ensure the bottom clamp was only holding the frame and not clamping the screen within the frame.

If during the testing, the frame came loose from the bottom clamp, the specimen was excluded from the data and the next fabric strip was tested.

The Following Results were Achieved:

The open mesh substrate had an average elongation at rupture of 29.5% when testing along the polyester fibers and 6.8% when testing along the fiberglass fibers during testing as measured by an ASTM D5035.

The open mesh substrate had an average tensile strength at rupture of 91.62 lbf (pound force) with the PET fibers perpendicular to the frame and 177.77 lbf with the fiberglass fibers parallel to the frame during testing.

The adhesion of the open mesh substrate to the frame was tested for two different configurations where in the frame: 1) the polyester fibers were in the long direction of the frame and the fiberglass fibers were in the short direction of the frame versus 2) the fiberglass fibers were in the long direction of the frame and the polyester fibers were in the short direction of the frame. In both instances, the polyester fibers had greater than 55% average adhesion strength to the frame compared to the fiberglass fibers.

### Further Testing of the Open Mesh Substrate Resulted in the Following:

Fabric stability of the insect screen in the first direction (warp/main) was 48.9 N and in the second direction (weft/cross) was 62.2 N as measured by ASTM D4912.

The open mesh substrate had a stiffness of about 120.3 mg in the first direction as measured by ASTM D3656 and a tear of 120.3 Newtons as measured by ASTM D5735.

Certain features, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An insect screen comprising:
a frame, wherein the frame has a flexible response when a pressure is applied to the frame and maintains a rigid shape when secured in a building opening; and
an open mesh substrate attached to the frame, wherein the open mesh substrate comprises a set of first fibers oriented in a first direction of said open mesh substrate, wherein the set of first fibers has a first adhesion strength to the frame; and
a set of second fibers oriented in a second direction that is perpendicular to the first direction, wherein the set of second fibers has a second adhesion strength to the frame, wherein the second direction is perpendicular to the first direction, wherein the first set of fibers and the second set of fibers are configured to intersect, and wherein the first adhesion strength is greater than the second adhesion strength.

2. The insect screen in accordance with claim 1, wherein the first set of fibers and the second set of fibers comprise fiberglass, steel, aluminum, polyester, polyethylene, polypropylene, polyamide, cellulose or combinations thereof.

3. The insect screen in accordance with claim 2, wherein the first set of fibers comprises polyester.

4. The insect screen in accordance with claim 2, wherein the second set of fibers comprises coated fiberglass.

5. The insect screen in accordance with claim 1, wherein the first set of fibers and the second set of fibers are configured in a plain weave.

6. The insect screen in accordance with claim 1, wherein the first set of fibers and the second set of fibers in the open mesh substrate are present at 1 fiber per centimeter to 30 fibers per centimeter.

7. The insect screen in accordance with claim 1, further comprising at least one polymer coating on the first set of fibers, the second set of fibers, or combination thereof.

8. The insect screen in accordance with claim 1, wherein the open mesh substrate has an openness of greater than 30%.

9. The insect screen in accordance with claim 1, wherein the open mesh substrate is secured to the frame via welding, an adhesive, or combination thereof.

10. The insect screen in accordance with claim 1, wherein the first adhesion is greater than 5.8 pound force (lbf), such as 5.8 lbf to 8.5 lbf as measured by a modified ASTM D5035.

11. The insect screen in accordance with claim 1, wherein the second adhesion is less than 5.5 pound force (lbf), such as 3.5 lbf to 5.5 lbf as measured by a modified ASTM D5035.

12. The insect screen in accordance with claim 1, wherein the screen has a fabric stability of about 50 Newtons to about 80 Newtons in the second direction as measured by ASTM D4912.

13. The insect screen in accordance with claim 1, wherein the screen has a fabric stability of about 30 Newtons to about 70 Newtons as measured by ASTM D4912 in the first direction.

14. The insect screen in accordance with claim 1, wherein the open mesh substrate has a stiffness of about 100 mg to about 700 mg, such as about 300 mg to about 600 mg in the first direction as measured by ASTM D3656.

15. The insect screen in accordance with claim 1, wherein the open mesh substrate has at least one of:
a) a tear strength of about 75 Newtons to about 150 Newtons as measured by ASTM D5735;
b) an elongation at rupture of greater than 20%, such as 20% to 40% in the first direction as measured by ASTM D5035; or
c) an elongation at rupture of less than 15%, such as 1% to 15% in the second direction as measured by ASTM D5035.

16. The insect screen in accordance with claim 1, wherein the frame comprises at least one spring-like side member.

17. The insect screen in accordance with claim 1, wherein the frame comprises spring steel.

18. A method of making an insect screen comprising:
orienting in a first direction of an open mesh substrate a first set of fibers;
orienting in a second direction of the open mesh substrate a second set of fibers, where the second direction is perpendicular to the first direction, wherein the first set of fibers and the second set of fibers are configured to intersect;
fixing the first set of fibers together with the second set of fibers; and
fixing the open mesh substrate to a frame, wherein the frame has a flexible response when a pressure is applied to the frame and maintains a rigid shape when secured in a building opening; wherein the first set of fibers has a first adhesion strength to the frame and the second set of fibers has a second adhesion strength to the frame and wherein the first adhesion strength is greater than the second adhesion strength.

19. The method of making the insect screen in accordance with claim 18, wherein fixing the open mesh substrate to the frame comprises welding the open mesh substrate to the frame.

20. An insect screen comprising:
a frame, wherein the frame has a flexible response when a pressure is applied to the frame and maintains a rigid shape when secured in a building opening; and
an open mesh substrate attached to the frame, wherein the open mesh substrate comprises a set of polymer fibers oriented in a first direction of said open mesh substrate, wherein the set of polymer fibers has a first adhesion strength to the frame; and
a set of coated fiberglass fibers oriented in a second direction that is perpendicular to the first direction, wherein the set of coated fiberglass fibers has a second adhesion strength to the frame, wherein the second direction is perpendicular to the first direction, wherein the set of polymer fibers and the set of coated fiberglass fibers are configured to intersect, and wherein the first adhesion strength is greater than the second adhesion strength.
